(19) United States
(12) Patent Application Publication
(10) Pub. No.: US 2024/0388243 A1
(43) Pub. Date: Nov. 21, 2024

(54) LINKED SOLAR TRACKERS

(71) Applicant: Nextracker LLC, Fremont, CA (US)

(72) Inventors: Raghavendra Praveen Maddulapalli, Vijayawada (IN); Abhimanyu Anil Sable, Hyderabad (IN); Ashwajit Wahane, Kalyan (IN); Jitendra Morankar, Hyderabad (IN); Phani Kumar, Hyderabad (IN); Ricardo Delgado-Nanez, San Jose, CA (US); Venkata Nitin Mythreya Yadlapalli, Nellore (IN); Bhanu Rekha Bandhakavi, Hyderabad (IN)

(21) Appl. No.: 18/664,683

(22) Filed: May 15, 2024

Related U.S. Application Data
(60) Provisional application No. 63/466,899, filed on May 16, 2023.

(51) Int. Cl. H02S 20/32

(52) U.S. Cl. CPC H02S 20/32

(57) ABSTRACT

A solar tracker system including at least two solar trackers arranged substantially in parallel, each solar tracker including a torque tube and a plurality of piers supporting the torque tube, a drive mechanism mounted on one of the plurality of piers associated with a first of the at least two solar trackers to rotate the first of the at least two solar trackers, a pulley mounted on each torque tube of the at least two solar trackers, and a cable connecting the pulley of the first of the at least two solar trackers to the pulley of a second of the at least two solar trackers, wherein rotation of the first of the at least two solar trackers is translated to the second of the at least two solar trackers via the cable.

### PRIORITY APPLICATIONS

This application claims the benefit of U.S. Provisional Patent Application No. 63/466,899, filed May 16, 2023, the entire contents of which are incorporated herein by reference.

### TECHNICAL FIELD

The present disclosure relates to solar power generation systems, and more particularly, to solar tracker systems for adjusting the orientation of the solar power generation components to track the location of the sun.

### BACKGROUND

Solar cells and solar panels are most efficient in sunny conditions when oriented towards the sun at a certain angle. Many solar panel systems are designed in combination with solar trackers, which follow the sun's trajectory across the sky from east to west in order to maximize the electrical generation capabilities of the systems. The relatively low energy produced by a single solar cell requires the use of thousands of solar cells, arranged in an array, to generate energy in sufficient magnitude to be usable, for example as part of an energy grid. As a result, solar trackers have been developed that are quite large, spanning hundreds of feet in length.

Adjusting massive solar trackers requires power to drive the solar array as it follows the sun. As will be appreciated, the greater the load, the greater the amount of power necessary to drive the solar tracker. An additional design constraint of such systems is the rigidity required to accommodate the weight of the solar arrays and at times significant wind loading.

Further, the torsional excitation caused by wind loading exerts significant force upon the structure for supporting and the mechanisms for articulating the solar tracker. As such, increases in the size and number of components to reduce torsional excitation are required at varying locations along the length of the solar tracker. The present disclosure seeks to address the shortcomings of prior tracker systems.

### SUMMARY

One aspect of the disclosure is directed to a solar tracker system including at least two solar trackers arranged substantially in parallel, each solar tracker including a torque tube and a plurality of piers supporting the torque tube; a drive mechanism mounted on one of the plurality of piers associated with a first of the at least two solar trackers to rotate the first of the at least two solar trackers; a pulley mounted on each torque tube of the at least two solar trackers; and a cable connecting the pulley of the first of the at least two solar trackers to the pulley of a second of the at least two solar trackers, where rotation of the first of the at least two solar trackers is translated to the second of the at least two solar trackers via the cable. Other embodiments of this aspect include corresponding computer systems, apparatus, and computer programs recorded on one or more computer storage devices, each configured to perform the actions of the methods and systems described herein.

Implementations of this aspect of the disclosure may include one or more of the following features. The solar tracker system further including two cables, one configured to connect on top of the torque tubes of the at least two solar trackers and one configured to connect below the torque tubes of the at least two solar trackers. The solar tracker system further including a fastener connected to each end of the two cables and configured to secure the two cables to the pulley mounted on each torque tube of the at least two solar trackers. The pulley mounted on each solar tracker is mounted near a mid-point of the at least two solar trackers. The solar tracker system where the pulley mounted on each solar tracker is mounted near an end of the at least two solar trackers. The solar tracker system further including a plurality of pulleys mounted on each torque tube of the at least two solar trackers. The solar tracker system further including a pair of cables connecting the plurality of pulleys mounted on the torque tube of a first of the at least two solar trackers to the plurality of pulleys mounted on the torque tube of the second of the at least two solar trackers. The solar tracker system further including at least one pulley mounted on a first pier of the plurality of piers supporting the first of the at least two solar trackers and at least one pulley mounted on a first pier of the plurality of piers supporting the second of the at least two solar trackers. The solar tracker system further including a cable connecting the pulley mounted on the torque tube of the first of the at least two solar trackers to the pulley mounted on the first pier of the plurality of piers supporting the first of the at least two solar trackers. The solar tracker system further including a cable connecting the pulley mounted on the torque tube of the first of the at least two solar trackers to the pulley mounted on the first pier of the plurality of piers supporting the second of the at least two solar trackers. Implementations of the described techniques may include hardware, a method or process, or computer software on a computer-accessible medium, including software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

### BRIEF DESCRIPTION OF THE DRAWINGS

Various aspects and features of the present disclosure are described hereinbelow with reference to the drawings, wherein:

FIG. 1 is a perspective view of a solar tracking system provided in accordance with the present disclosure configured to articulate the angle of a solar array to track the location of the sun;

FIG. 2 depicts a pair of linked solar trackers in accordance with the disclosure;

FIG. 3 depicts three linked solar trackers in accordance with the disclosure;

FIG. 4 depicts four linked solar trackers in accordance with the disclosure;

FIG. 5 depicts three linked solar trackers with a drive mechanism in a center position in accordance with the disclosure;

FIG. 6 depicts five linked solar trackers with a drive mechanism in a center position in accordance with the disclosure;

FIG. 7 depicts a pair of linked solar trackers in accordance with the disclosure;

FIG. 8 depicts the ends of the pair of linked solar trackers of FIG. 7 in accordance with the disclosure;

FIG. 9 depicts a pair of solar trackers with two linkages in accordance with the disclosure;

FIG. 10A depicts pair of linked solar trackers with a smart panel and solar modules in accordance with the disclosure;

FIG. 10B depicts pair of linked solar trackers with a smart panel and solar modules in accordance with the disclosure;

FIG. 11 depicts a pair of linked solar trackers employing cables in accordance with the disclosure;

FIGS. 12A-12C depict the movement of two solar trackers connected via cables of FIG. 11;

FIG. 13A-13F depict a further aspect of the disclosure with a pair of linked trackers employing cables and pulleys in accordance with the disclosure; and

FIG. 14A-14C depict further aspect of the disclosure with a pair of linked trackers employing cables and pulleys in accordance with the disclosure.

### DETAILED DESCRIPTION

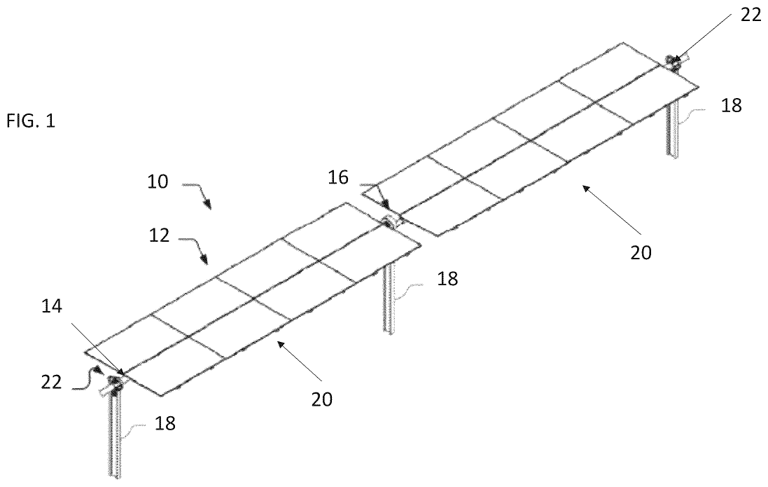

FIG. 1 depicts a bottom perspective view of a portion of a single-axis solar tracker 10, the solar tracker 10 includes a plurality of solar modules 12 mounted on a torque tube 14. A drive mechanism 16 is operably connected to the torque tube 14. As shown in FIG. 1, the torque tube 14 is connected to the drive mechanism 16. In some aspects the drive mechanism may off-set (i.e., the axis of rotation of the drive mechanism 16 is offset from the longitudinal axis of the torque tube 14). The drive mechanism 16 is mounted on a pier 18 that is driven into the ground. A plurality of the piers 18 support the entirety of the solar tracker 10.

As will be appreciated, when the drive mechanism 16 is energized, the motor overcomes the forces of gravity and any wind loading experienced by the solar tracker 10 to drive the solar tracker 10 to a desired orientation to maximize the solar energy collection capabilities of the solar modules 12 mounted on the torque tube 14. The solar tracker is formed such that a plurality of bays 20 are formed, each bay 20 defined by the distance between piers 18.

At each pier 18 is either a bearing 22 or the drive mechanism 16. Each of the bearings 22 and the drive mechanism 16 are supported by one of the piers 18. Activation of the drive mechanism 16 rotates the torque tube 14 about an axis of rotation and thus rotates the solar modules 12 mounted to the torque tube 14 such that the solar modules can be oriented to a desired position. That desired position may be to a position to capture maximum sunlight based on the location of the sun in the sky, that position may be to a 0-angle position during times of diffuse light, the desired position may be a safety position based on weather conditions such as high winds or a snow storm, or any position in between as desired by the operators of the solar power plant in which the solar tracker 10 is located given the current weather and atmospheric conditions, the current demands of the grid, and other factors. The bearings 22 reduce to the extent possible the resistance to movement of the torque tube 14 and the solar modules 12.

The torque tube 14 is sized (e.g., diameter, wall thickness, material) such that sag between the piers 18 is reduced or substantially eliminated and to absorb torsional loads applied to the torque tube 14 by wind loading. In addition, since there is just a single drive mechanism 16, the specifications for the torque tube 14 must also seek to eliminate twist of the torque tube 14 along its length. Any twist would result in the solar modules being oriented differently from what is desired, and thus again reduce the output and efficiency of the solar tracker 10, particularly, as the solar tracker is rotated to the extreme angles of permitted range (e.g., +/−60 degrees or more).

In practice, each solar tracker 10, of which there may be hundreds in a given solar power plant, is driven by a single drive mechanism 16. However, this arrangement requires that each solar tracker 10 be individually controlled. There are additional costs with providing a drive mechanism 16 for each solar tracker, in addition there is not insignificant coordination required to control each solar tracker 10 individually to ensure that each solar tracker rotates to follow the sun or move to a stow position. Accordingly, this disclosure is directed at addressing some of these issues.

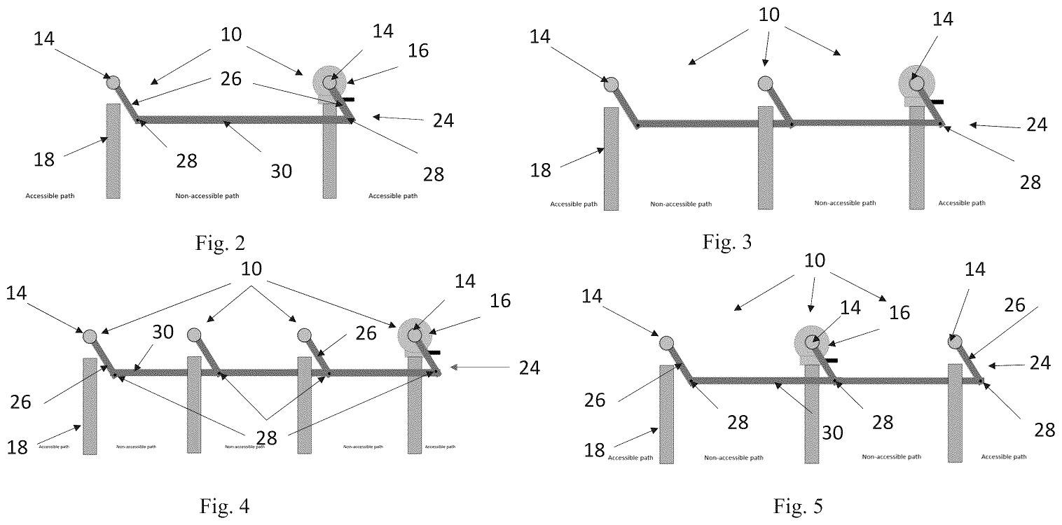

FIGS. 2-5 depict a variety of arrangements of linked solar trackers. FIG. 2 is an end view of two adjacent solar trackers 10. One solar tracker includes the drive mechanism 16 connected to the torque tube 14, and the torque tube 14 of the second solar tracker 10 is connected to the torque tube 14 of the first solar tracker via a linkage 24. Rotation of the torque tube 14 of the first solar tracker 10, translates through the linkage 24 to rotate the torque tube 14 of the second solar tracker 10. Via the linkage 24, the rotational position of the torque tube 14 of the first solar tracer 10 and the torque tube 14 of the second solar tracker 10 are kept in sync and ensure that the solar modules 12 of the first solar tracker 10 and the second solar tracker 10 are oriented in the same direction.

The linkage 24 is formed of two lever arms 26, each rigidly attached to one of the torque tubes 14. A pin 28 connects each lever arm 26 to a tube 30 which spans between the torque tubes 14 and the solar trackers 10. FIGS. 3 and 4 show that multiple solar trackers 10 can be linked by the linkage 24. As will be appreciated the tube 30, may be formed sufficiently long enough to span the multiple solar trackers 10, or the tube 30 may be formed of multiple tubes 30 that are interconnected with each other to span the appropriate length and connect to each lever arm 26. The total number of solar trackers 10 that can be driven by a single drive mechanism 16 is based on the weight of the solar modules 12, the friction of the bearings 22 supporting the torque tube 14, and any resistance to movement offered by the wind. FIG. 3 shows three solar trackers 10 connected via the linkage 24 and FIG. 4 shows four solar trackers 10 connected via the linkage 24. In any given solar power plant, where hundreds of solar trackers 10 can be employed, various combinations of linkages 24 may be employed. For example, it might be desirable for 2 or 3 solar trackers 10 on the eastern most edge of the power plant to be linked together, and for the 2 or 3 solar trackers on the western most edge of the power plant to be linked together. Thus the solar trackers 10 on the windward edge of the solar power plant can be utilized as a wind fence at times of high wind, allowing the remaining solar trackers 10 to continue normal operation and limit the generation capability that might occur if all the solar trackers 10 were moved to a high wind stow position.

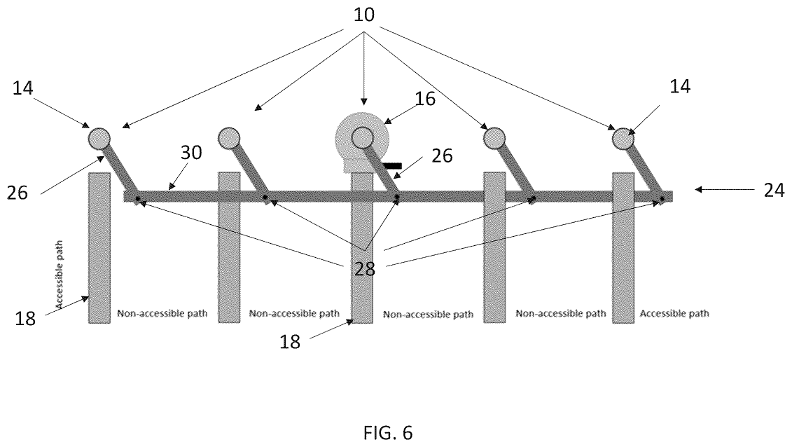

The drive mechanism 16 may be placed on any of the linked trackers 10. FIGS. 5 and 6 show the drive mechanism 16 on a center solar tracker 10 of the linked solar trackers. In contrast FIGS. 2-4 show the drive mechanism 16 on an end solar tracker 10 of the linked solar trackers. The drive mechanism 16 may be located on any pier 18 along the length of the solar tracker 10 including in the middle of the length of the solar tracker 10, or on an end pier 18, without departing from the scope of the disclosure.

One of the challenges of the use of the linkage 24 is that it limits the accessibility between the solar trackers 10. The limitation of accessibility provides challenges to mowing and other activities that occur between the solar trackers 10. However, the benefits of the linkage in the operation of the solar trackers 10 can outweigh these limitations, further, by limiting the length of the lever arms 26, the limitations on accessibility may be minimized.

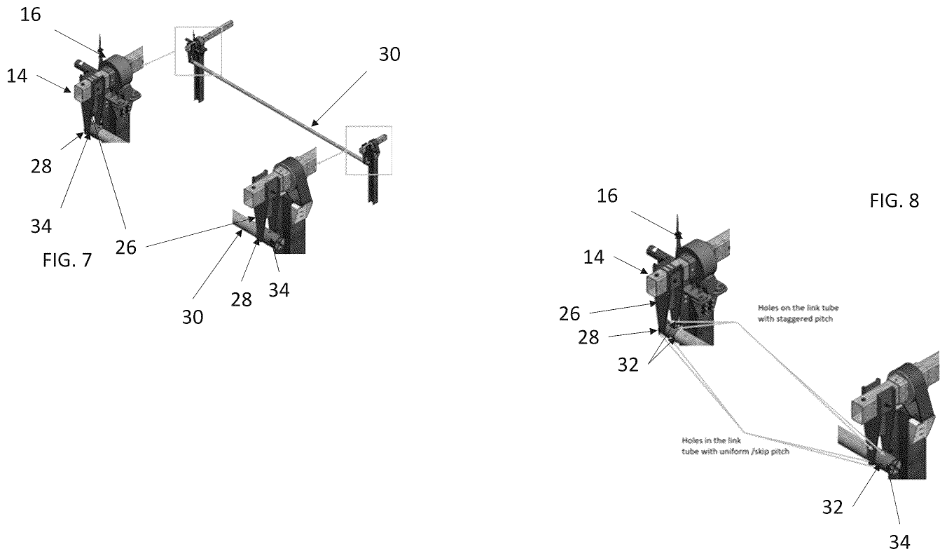

FIG. 7 depicts another view of two solar trackers 10 linked via a linkage 24. As can be seen, the lever arms 26 are bolted or otherwise secured to the torque tubes 14 of two parallel solar trackers 10. In this example, the toque tubes 14 are square or rectangular, but they may take any format without departing from the scope of the disclosure including D-shaped, round, etc. The tube 30 connects the two solar trackers 10. As noted above, the pins 28 allow the lever arms 26 to rotate relative to the tube 30 when the drive mechanism 16 rotates the torque tube 14, yet still transfer motion from the solar tracker 10 with the drive mechanism to a solar tracker 10 without a drive mechanism. As shown in FIGS. 7 and 8 the pins 28 may be through bolts connecting the tube 30 to the lever arms 26.

Though depicted in FIGS. 7 and 8 with the tube 30 proximate the drive mechanism 16 on a first solar tracker 10 and near a central bearing 22 on a second solar tracker 10, this positioning is not so limited. Rather, the tube 30 may be located at any location along the length of the solar tracker 10 including at the ends of the solar trackers 10.

Another aspect of the disclosure is the positioning of the holes 32 in the tube 30 and a collar portion 34 of the lever arms 26. The collar portions 34 may be secured first to the tube 30, and then just a single through bolt, which traverses the collar portion 34 and the tube 30, is needed to connect the tubes 30 to the lever arm 26, that through bolt forming the pin 28, as described above. Some of the holes 32 may be drilled in the collar portion 34 in a uniform or skip pitch. A second set of holes 32 may be drilled on the perpendicular plane with a staggered pitch. Having two sets of holes facilitates adjustability of the tube 30 with respect to the lever arms 26. This may be particularly useful in instances where there are changes in pitch and elevation between solar trackers 10. As with the torque tube 14, the cross-sectional geometry of the tube 30 can be circular (as shown) or alternatively rectangular, square, hexagonal, D-shaped, triple-D, and others.

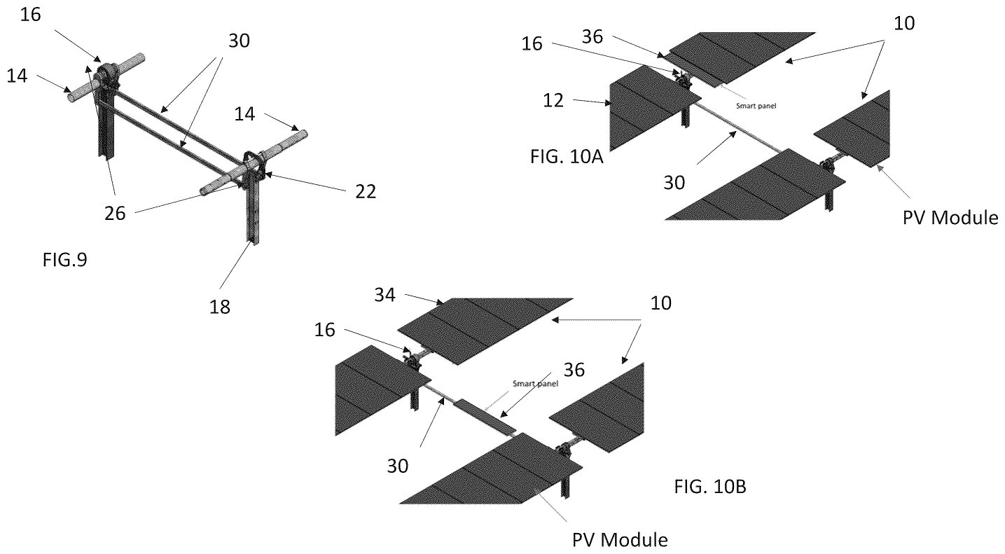

FIG. 9 depicts a further aspect of the disclosure. In FIG. 9, two tubes 30 are installed on either side of the drive mechanism 16 of the solar tracker 10 and the corresponding bearing 22 on the second solar tracker 10. Lever arm 26 can be formed of a single-piece cast component or a welded fabrication configured to receive the torque tube 14 on one end and the tube 30 on a second end.

The solar tracker 10 may be self-powered via a smart panel 36, which provides power and also energy generation data that can be analyzed by a controller (not shown) to assess the solar radiation levels impacting the solar modules 12. FIG. 10A depicts smart panel 36 in its traditional location on the torque tube 14. Note that in FIG. 10A the smart panel 36 is on an opposite side of the drive mechanism 16 from the linkage 24 However, in FIG. 10B the smart panel 36 is secured to the linkage 24.

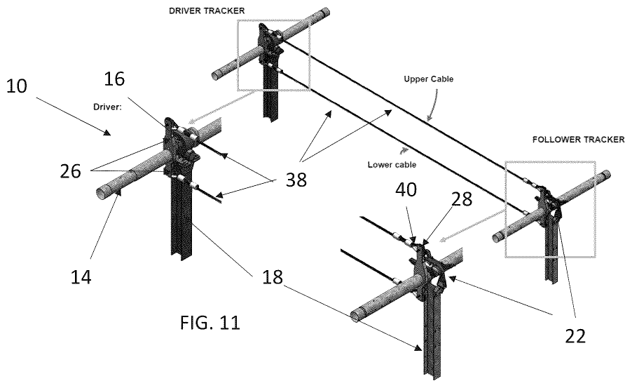

FIG. 11 depicts a further aspect of the disclosure. In FIG. 11, rather than a tube 30 made of, for example, steel pipe, cables 38 are employed. As depicted in FIG. 11 two cables 38 are used but, a single cable 38 could be similarly employed without departing from the scope of the disclosure. The cables 38 connect to a lever arm 26 which is connected to the torque tube 14. As is apparent, the lever arm 26 of FIG. 11 is a different form than the lever arm 26 of FIG. 7, for example, however, the function is the same, to transfer motion from the solar tracker 10 with the drive mechanism 16 to the solar tracker 10 with the bearing 22. Each cable 38 is connected to the lever arm 26 via a pin 28. In FIG. 11 each cable has a thimble 40 which supports the cable 38 as it passes through an opening in the lever arm 26. The thimble 40 provides chafe or wear protection during use. The cables 38 may be tensioned such that regardless of the direction of movement of the torque tube 14 of the first solar tracker 10 is transferred to the torque tube 14 of the second solar tracker. The cables may be steel cable (wire), steel chains, high strength natural or synthetic (polymer) wires or ropes.

As with other variants described herein the cables 38, and lever arms 26 may be at any location along the length of the solar tracker 10. In some aspects the cables 38 and lever arms 26 are located at one or both ends of the solar tracker, and in other instances may be located at a center of the solar tracker, for example near the drive mechanism 16 of the solar tracker 10 and the central bearing of a driven solar tracker 10.

As will be appreciated, by tensioning the cables 38 the stability of both solar trackers 10 is increased and vibrations along the length of the solar tracker 10 (e.g., as caused by the wind) can be reduced. Placement of the cables 38 and the lever arms 26 at the ends of the solar tracker 10 enhances the stabilization of the solar trackers 10.

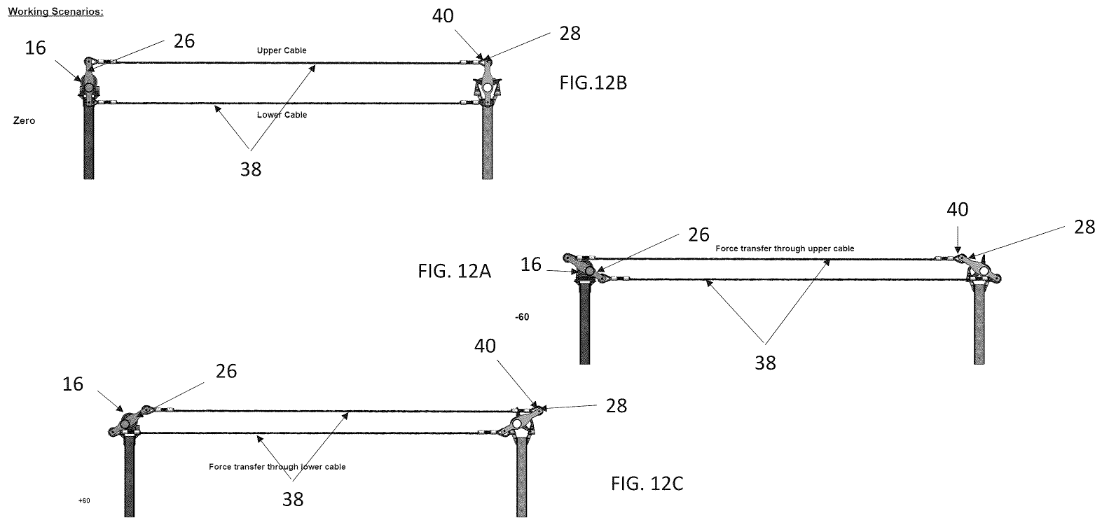

FIGS. 12A-12C depict the motion of two solar trackers 10 connected via two cables, one above and one below the torque tubes 14. In FIG. 12A the solar trackers 10 are in a −60 degree position where the solar modules 12 face generally eastward as the sun is rising. In FIG. 12B the solar trackers 10 are in the 0-degree position where the solar modules 12 would be oriented substantially horizontally, as would be necessary at near noontime when the sun is directly overhead. Finally, FIG. 12C depicts the solar trackers 10 oriented to the +60-degree position facing generally westward as the sun approaches sunset. As can be seen, the movement from the solar tracker 10 with the drive mechanism 16 is mirrored by the other solar tracker 10.

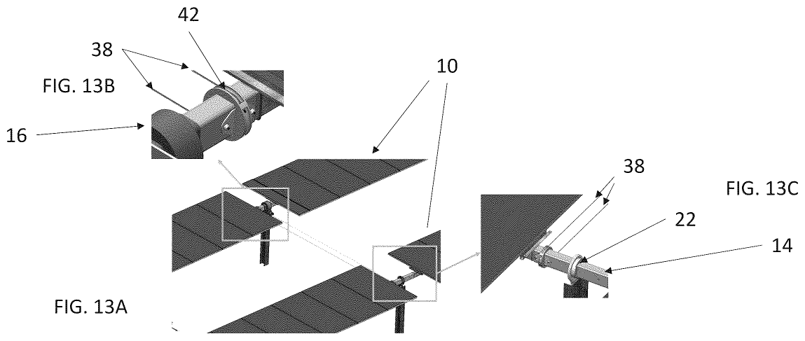

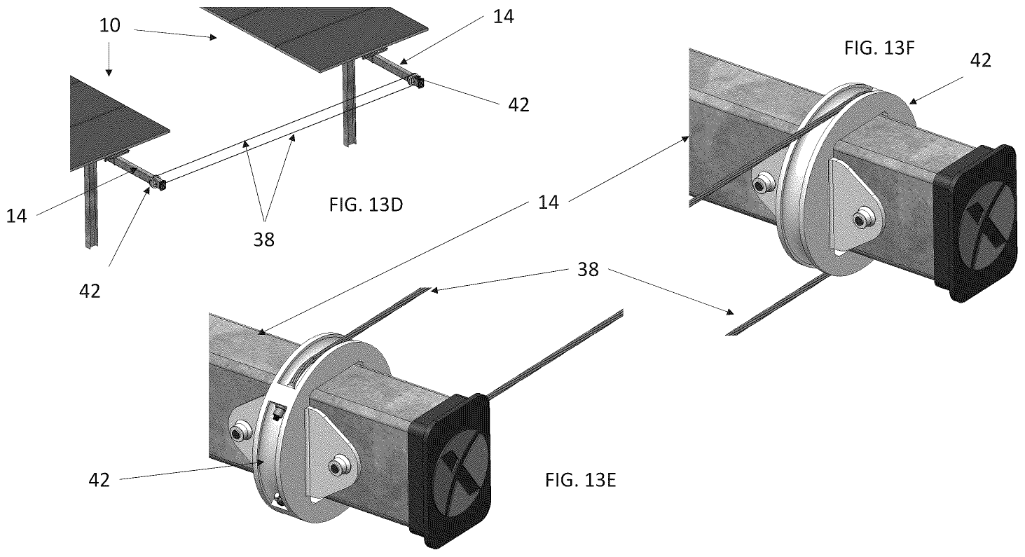

FIG. 13A-13C depict a further aspect of the disclosure. Rather than employing a lever arm 26 or linkage 24, pulleys 42 are employed on each torque tube 14 of the solar trackers 10. FIG. 13A depicts both solar trackers 10 connected by cables 38 running over pulleys 42. FIG. 13B depicts the pulley 42 next to the drive mechanism 16, whereas FIG. 13C depicts the corresponding pulley on the other solar tracker 10 proximate the bearing 22. Each pulley 42 may be formed of a two-piece construction that allows the pulley 42 to be attached to the torque tube 14.

The cables 38 may include a fasteners which are secured to one end of the cable 38. The fasteners may be secured via welding, swaging, or crimp connections, and other without departing from the scope of the disclosure. As shown in FIG. 13A-13C, two separate cables 38 are employed, one overtop of the torque tube 14 and one cable 38 below the torque tube 14. However, those of skill in the art will recognize that a single continuous cable 38 which wraps around the pulley 42 on one of the torque tubes 14 and both bitter ends are secured with a fastener on the pulley 42 of the other torque tube 14. The cables 38 are each independently secured to the pulleys 42 via the fasteners. The fasteners and specifically the securing of the fasteners, e.g., via swaging or welding can be used to tension the cables to ensure that the solar trackers 10 operate in unison with one another. Further, as cables 38 such as steel wire will stretch over time, the fastener may be removed or loosened so that the cables 38 may be periodically tensioned.

As with other aspects of the disclosure, the pulleys 42 and the cables 38 may be installed in a variety of locations along the length of the solar tracker 10, and also in multiple locations to ensure smooth transfer of motion from the drive mechanism 16 of one solar tracker 10 to the other solar trackers 10. For example, the pulleys 42 and cables 38 may be installed on both ends of the solar tracker 10 and/or near the drive mechanism 16. Further, because of the tensioning, the use of the cables 38 may reduce or eliminate the need for dampers on the solar trackers 10 to combat movement caused by the wind flowing over the solar modules 12 of the solar tracker 10.

FIG. 13D depicts two solar tracker 10 with cables 38 secured to pulleys 42 at the end of the solar trackers 10. FIG. 13E is a perspective view of a pulley mounted on a torque tube 14 showing the outboard side where the fasteners secure the cables 38 to the pulley 42. FIG. 13F depicts the inboard side of the pulley 42 where the cables 38 enter onto the pulley 42.

The aspects described in connection with FIGS. 13A-13F involve the securing of the pulleys 42 to the torque tubes 14. This provides the greatest vertical clearance of the cables from the ground, however, this benefit comes with the drawback that the cables 38 are not easily placed at points along the solar tracker 10 other than near the drive mechanism 16 and the ends of the solar tracker 10. As will be appreciated, at other locations along the solar tracker 10 the solar modules 12 may require a gap to be placed between two adjacent solar modules 12 such that the cables 38 and pulleys can be placed without interfering with the rotation of the solar tracker 10.

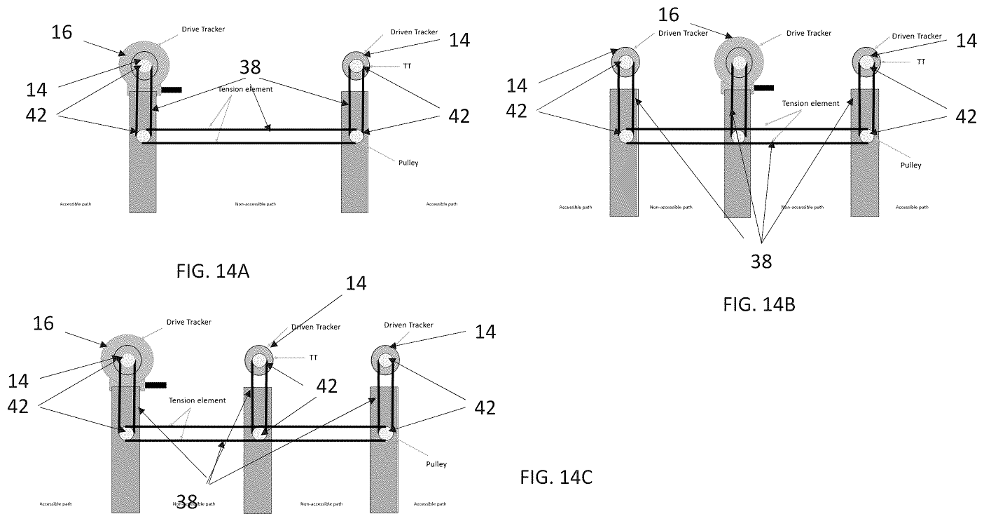

FIGS. 14A-14C depict a method of addressing some of the challenges of the use of the cables 38 in accordance with FIGS. 13A-13F. As can be seen in FIG. 14A, in addition to the pulleys 42 mounted on the torque tubes 14, two additionally pulleys 42 are mounted on the piers 18. As will be understood the pulleys 42 on the piers 18 are in line with the pulleys 42 on the torque tubes 14. The pulleys 42 on the piers may be of similar construction to the pulleys on the torque tubes 14 but will necessarily be a double pulley having two pulley wheels, one for integrating with the cable 38 from the torque tube 14, and one for integrating with the other pulley 42 on the neighboring pier 18.

As with other aspects of the disclosure, the cables 38 and the pulleys 42 may be located at any point along the length of the solar tracker 10 at which a pier 18 is located. The cables 38 descending from the torque tubes 14 are in series with the cable 38 extending between piers 18.

Though described as pulleys 42, the pulleys may be standard or custom-made pulleys or sprockets or combination thereof. The cables 38 may be formed of wire (e.g., steel wire), chain, and other natural or synthetic ropes described herein. The cables 38 are tensioned as described above to ensure transfer of movement from the drive mechanism 16 to neighboring solar trackers 10. The pulleys or sprockets or combinations may be formed to be secured on torque tubes of different cross-section including square, rectangle, D-shaped, round, and others.

A flexible mechanical joint can employed on the pulleys 42 on either solar tracker 10 to facilitate overcoming any misalignment between the solar tracker 10 caused due to construction tolerance in the installation of the foundation piles.

FIG. 14B depict an arrangement of a single drive mechanism 16 on a first solar tracker 10 being configured to drive multiple solar trackers 10 on either side of the solar tracker 10 with the drive mechanism 16. FIG. 14C depicts an arrangement of a single drive mechanism 16 on a first solar tracker 10 being configured to drive multiple other solar trackers 10 on one side of the first solar tracker 10.

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of embodiments. Those skilled in the art will envision other modifications within the scope and spirit of the claims appended hereto.

1. A solar tracker system comprising:
at least two solar trackers arranged substantially in parallel, each solar tracker including a torque tube and a plurality of piers supporting the torque tube;
a drive mechanism mounted on one of the plurality of piers associated with a first of the at least two solar trackers to rotate the first of the at least two solar trackers;
a pulley mounted on each torque tube of the at least two solar trackers; and
a cable connecting the pulley of the first of the at least two solar trackers to the pulley of a second of the at least two solar trackers, wherein rotation of the first of the at least two solar trackers is translated to the second of the at least two solar trackers via the cable.

2. The solar tracker system of claim 1, further comprising two cables, one configured to connect on top of the torque tubes of the at least two solar trackers and one configured to connect below the torque tubes of the at least two solar trackers.

3. The solar tracker system of claim 2, further comprising a fastener connected to each end of the two cables and configured to secure the two cables to the pulley mounted on each torque tube of the at least two solar trackers.

4. The solar tracker system of claim 2, wherein the pulley mounted on each solar tracker is mounted near a mid-point of the at least two solar trackers.

5. The solar tracker system of claim 2, where the pulley mounted on each solar tracker is mounted near an end of the at least two solar trackers.

6. The solar tracker system of claim 2, further comprising a plurality of pulleys mounted on each torque tube of the at least two solar trackers.

7. The solar tracker system of claim 6, further comprising a pair of cables connecting the plurality of pulleys mounted on the torque tube of a first of the at least two solar trackers to the plurality of pulleys mounted on the torque tube of the second of the at least two solar trackers.

8. The solar tracker system of claim 1, further comprising at least one pulley mounted on a first pier of the plurality of piers supporting the first of the at least two solar trackers and at least one pulley mounted on a second pier of the plurality of piers supporting the second of the at least two solar trackers.

9. The solar tracker system of claim 8, further comprising a cable connecting the pulley mounted on the torque tube of the first of the at least two solar trackers to the pulley mounted on the first pier of the plurality of piers supporting the first of the at least two solar trackers.

10. The solar tracker system of claim 9, further comprising a cable connecting the pulley mounted on the torque tube of the first of the at least two solar trackers to the pulley mounted on the first pier of the plurality of piers supporting the second of the at least two solar trackers.

11. A solar tracker system comprising:
at least two solar trackers arranged substantially in parallel, each solar tracker including a torque tube and a plurality of piers supporting the torque tube;
a drive mechanism mounted on one of the plurality of piers associated with a first of the at least two solar trackers to rotate the first of the at least two solar trackers; and
two cables, one configured to connect on top of the torque tubes of the at least two solar trackers and one configured to connect below the torque tubes of the at least two solar trackers
two cables, each connecting a first of the at least two solar trackers to a second of the at least two solar trackers, wherein rotation of the first of the at least two solar trackers is translated to the second of the at least two solar trackers via the two cables.

12. The solar tracker system of claim 11, wherein one of the two cables is configured to connect on top of the torque tubes of the at least two solar trackers and another one of the two cables is configured to connect below the torque tubes of the at least two solar trackers.

13. The solar tracker system of claim 11, further comprising a pulley mounted on each torque tube of the at least two solar trackers, and wherein the two cables connecting the pulley of the first of the at least two solar trackers to the pulley of a second of the at least two solar trackers.

14. The solar tracker system of claim 13, further comprising a plurality of pulleys mounted on each torque tube of the at least two solar trackers, and the two cables connecting the plurality of pulleys mounted on the torque tube of the first of the at least two solar trackers to the plurality of pulleys mounted on the torque tube of the second of the at least two solar trackers.

15. The solar tracker system of claim 13, further comprising at least one pulley mounted on a first pier of the plurality of piers supporting the first of the at least two solar trackers and at least one pulley mounted on a first pier of the plurality of piers supporting the second of the at least two solar trackers.
